(19) United States
(12) Patent Application Publication
(10) Pub. No.: US 2014/0369081 A1
(43) Pub. Date: Dec. 18, 2014

(54) POWER CONVERTER

(71) Applicant: MICROSEMI CORPORATION, Aliso Viejo, CA (US)

(72) Inventor: Sanjaya Maniktala, Aliso Viejo, CA (US)

(21) Appl. No.: 13/921,058

(22) Filed: Jun. 18, 2013

(51) Int. Cl. H02M 3/335

(52) U.S. Cl. CPC H02M 3/33507
USPC 363/21.02

(57) ABSTRACT

LLC power converters are disclosed that operate in the soft switching region and are defined by a range of frequencies within which soft switching occurs. The LLC power converters include an LLC tank circuit in which the values of the inductors and the capacitors are scaled by a frequency scaling factor and a power scaling factor based on selected design parameters for the LLC power converter. The switching frequency of the disclosed LLC power converters can be varied by an output voltage to switching frequency controller.

### BACKGROUND OF THE INVENTION

Conventional “square-wave” power converters rely on a catch diode to provide a diversionary diode path for existing inductor current when a switch, such as a field effect transistor (FET), turns OFF. Without a catch diode, the conventional power converter would need a switch placed in series with the inductor that would be turned OFF, which results in large spikes in voltage from the inductor current having nowhere to go and a destroyed switch. Power converter switches are turned ON and OFF repeatedly, sometimes hundreds of thousands of times every second, which requires a reliable path for the existing inductor current when the switch is turned OFF. Diversion of the inductor current to the catch diode in conventional power converters has some consequences, which notably include a resulting transitory period when the catch diode is in the process of taking the inductor current. Essentially, there is no instantaneous reduction of current in the FET and a full rail-to-rail voltage swing must be completed across the FET to forward-bias the catch diode (i.e., to cause the catch diode to start taking some of the current away from the FET).

During the voltage swing in the FET, an overlap of voltage and current exists across the FET, which results in crossover or “hard switching” losses in the FET. The reduction of switching losses during the few nanoseconds of switch state transition (crossover of the FET) is critical to improving conversion efficiency. Further, the hard switching losses in the FET are the main source of electromagnetic interference (EMI) in conventional power converters. Soft switching techniques can be used to reduce the crossover losses and resulting EMI of power converters. Soft switching techniques often rely on an input block, such as an inverter in a DC-DC converter, coupled with a resonant tank circuit at the output of the inverter, and an output block, such as a rectifier at the output of the resonant tank circuit in a DC-DC converter. The resonant tank circuit serves as an energy buffer or energy flow regulator between the source and the load.

To date, resonant switching or “soft switching” power converters have been limited to a relatively small range of input voltages that can achieve and maintain the desired design output voltage in the preferred operating range of the converter. Some existing resonant power converters use “L-L-C” topologies, which are a combination of two inductors and a capacitor, to offer a narrow range of switching frequencies and an easier topology for which to design the required EMI filters. LLC topologies for resonant power converters also can produce zero-voltage switching (ZVS) or “soft” switching, which provides the added benefit of reducing EMI and softly reducing the voltage-current (V-I) overlap to almost zero during the switching process by self-resonant action. A reduction in the switching losses during the few nanoseconds of switch state-transition (i.e., crossover of a FET) leads to improved conversion efficiency from ON and OFF switched states of the power converter over conventional square-wave switching power conversion techniques.

However, resonant LLC topologies are still considered very complex and impractical for a commercial product because their designs are based on trial and error, both in a real lab environment and in a virtual lab using simulators. Further, resonant LLC topologies are limited to a narrow input voltage range in the high voltage region because they are run from a well-regulated high voltage DC (HVDC) output rail of a conventional power factor correction (PFC) front-end in an AC-DC application, which produces very few input voltage swings.

The power converter industry would benefit from switching power converters that accomplish soft-switching with a resonant topology that reduce switching loss, reduce EMI, and provide for a large range of input voltages for a maintained output design voltage. These and other drawbacks of the current power converter technologies are addressed by the disclosed invention.

### SUMMARY OF THE INVENTION

One aspect of the invention includes an LLC converter stage for a soft-switching power converter. The LLC converter stage has a design maximum input voltage and a design output voltage. The LLC converter includes an output voltage to switching frequency controller, a first inductor, a second inductor electrically coupled in series with the first inductor, and a capacitor electrically coupled in series with both the first inductor and the second inductor. The values of the first inductor, the second inductor, and the capacitor are selected such that the design output voltage is maintained over a range of input voltages at least 65% to 100% of the design maximum input voltage while maintaining efficiency of at least 90% at the maximum design load. In other examples, the range of input values is 50% to 100% and can also be 25% to 100% of the design input voltage. In other examples, the design output voltage is maintained while the load varies between the maximum design load and 50% of the maximum design load.

Still further, other aspects of the invention include methods of determining values for an LLC converter stage in a soft-switching power converter that include selecting values for an LLC kernel that includes a first inductor, a second inductor electrically coupled in series with the first inductor, and a capacitor electrically coupled in series with the first inductor and the second inductor. The values of the first inductor, the second inductor, and the capacitor are selected such that the design output voltage is maintained over a range of input voltages from at least 65% to 100% of the design input voltage with an efficiency of at least 90% at maximum design load over the input voltage range 65-100%. The values of the first inductor, the second inductor, and the capacitor are adjusted based on a ratio of a maximum frequency of the LLC kernel and a minimum frequency of the kernel. The values of the first inductor, the second inductor, and the capacitor are further adjusted based on a ratio of a peak power output of the kernel at maximum line and a peak power output when the maximum design load is applied to the kernel.

The foregoing and other objects, features and advantages of the invention will become more readily apparent from the following detailed description of a preferred embodiment of the invention which proceeds with reference to the accompanying drawings.

### BRIEF DESCRIPTION OF THE DRAWINGS

FIG. 1A is a block diagram of a prior art resonant power converter.

FIG. 1B is a block diagram of a prior art DC-DC resonant power converter.

FIG. 1C is a block diagram of a DC-DC resonant power converter with a frequency scaled and power scaled LLC resonant tank circuit, in accordance with aspects of the invention.

FIG. 2A is an example LC resonant tank circuit and FIG. 2B is a corresponding graph depicting the phase angle of impedance and frequency.

FIG. 3A is an example LLC resonant tank circuit and FIG. 3B is a corresponding graph depicting the phase angle of impedance and frequency, according to aspects of the invention.

FIG. 4 is a graph of the conversion ratio and frequency showing the minimum and maximum resonant frequency spikes, for regulating line of the LLC tank circuit of FIG. 3A.

FIG. 5 is a graph of the conversion ratio and frequency showing the minimum and maximum resonant frequency spikes, for regulating load of the LLC tank circuit of FIG. 3A.

FIG. 6 is a graph of the impedance presented by the LLC tank circuit to the input source and frequency of the exemplary LLC tank circuit shown in FIGS. 3-5.

FIG. 7 is a block diagram showing some steps in determining values for an LLC tank circuit, according to aspects of the invention.

### DETAILED DESCRIPTION

In the drawings, which are not necessarily to scale, like or corresponding elements of the disclosed systems and methods are denoted by the same reference numerals. The values identified in the example circuits described herein are merely one example of a set of values and are not limiting on the invention. Any suitable values may be selected for the circuit components in accordance with the scaling concepts described herein.

To provide a wide ranging efficient power converter, an inductor (L), inductor (L), capacitor (C) power converter (LLC converter) is disclosed that defines a broad range of input voltage swing while maintaining the output voltage over the full range of load values and ensuring that the switching frequency is always between the two resonant frequency peaks defined by the values of the LLC converter elements. The disclosed LLC converters are regulated by an output voltage to switching frequency controller that can vary the frequency of the LLC converter. Through the selected values of the LLC converter elements, an inductive phase angle is obtained (i.e., current lagging voltage) at both the maximum and minimum input voltages, the inductive phase angle measured when the applied load is at its maximum value.

The frequency switching of the disclosed LLC converters is preferably within the soft-switching, or zero-voltage switching (ZVS) region of operation of the power converter, which thus prevents the additional stress that the power converter would have to withstand if the power converter operated in the hard switching region of operation, considerably reduces transient effects and reduces the power loss that occurs during the switching. The capacitor, C, of the LLC tank circuit of the LLC converter resonates with each of the individual inductors, LL, because the capacitor and each of the inductors have complementary phase angles. The two inductors, LL, of the LLC tank circuit do not resonate with each other because they do not share the same phase angle with each other. Therefore, the two resonant frequencies at which the capacitor, C, resonates with each inductor, LL, define a range of frequencies within which soft-switching can occur over a full load range. At light loads, the frequency of the LLC converter shifts close to the value of the higher resonant frequency of the LLC tank circuit. At heavy loads, the frequency of the LLC converter shifts close to the value of the lower resonant frequency of the LLC tank circuit.

All of these features of the disclosed LLC converter and the associated design methodologies allow for an increased input voltage range for the LLC power converter while still maintaining the overall utility and benefits of the resonant soft-switching topologies with its associated high efficiency. Thus, the disclosed LLC converters and design methodologies reduce the switching losses that occur during the switch state transition or crossover of the FET.

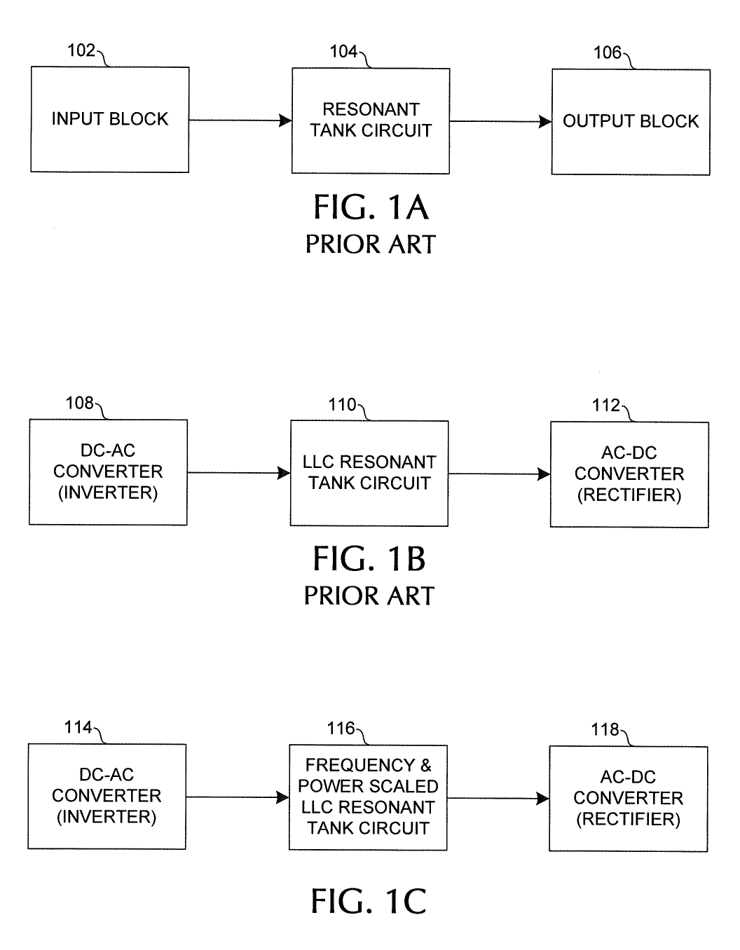

FIGS. 1A and 1B show prior art solutions to control the negative effects of the transient period of switching within the soft-switching region of resonant power converters. FIG. 1A shows a power converter having an input block 102, a resonant tank circuit 104, and an output block 106. The input block 102 is any suitable input power converter, such as direct current (DC) to DC converters, DC to alternating current (AC) converters, AC to DC converters, and another other power converters. The output block 102 is any suitable complementary converter to the input block 102. For example, if the input block 102 is a DC-AC converter (inverter), the output block 106 is then an AC-DC converter (rectifier).

The resonant tank circuit 104 can be a variety of topologies in the conventional resonant power converters, such a phase-shift modulated resonant converter or any load-resonant converters like series, parallel or series-parallel resonant converters. The resonant tank circuit 104 includes reactive components (inductors and capacitors) that store energy, but do not dissipate any stored energy. The resonant tank circuit 104 also includes some form of resistance, such as an intervening parasitic inductance or resistance in the form of an applied load that dissipates the energy stored in the inductors and capacitors. The applied load can be applied by a turn-ratio winding that is coupled to the second inductor of the LLC tank circuit 104.

The inductors and capacitors are able to pass energy back and forth between each other because they have complementary phase angles. The resonant topologies pass energy between the inductors and the capacitors from the input (source) to the output (load) and the ability to create DC regulation. The resonant tank circuit 104 serves as an energy buffer or energy flow regulator between the input block 102 and the output block 106 of the power converter.

A more specific example of a conventional resonant power converter is shown in the block diagram shown in FIG. 1B. The power converter of FIG. 1B is a DC-DC power converter that relies on an LLC resonant tank circuit for energy flow regulation. The LLC power converter shown in FIG. 1B includes a DC-AC converter or invertor 108, an LLC resonant tank circuit 110, and an AC-DC converter or rectifier 112. The LLC power converters, such as the example shown in FIG. 1B, offer a narrow range of switching frequencies and an easier topology for which to design any required EMI filters. LLC power converters can be designed to provide soft-switching, which also reduces EMI and improves the overall efficiency of the converter. However, conventional LLC power converters are complex to design and are limited to a narrow input voltage range in the high voltage operating region of the power converter.

As indicated above, conventional resonant or soft-switching power converters, including the example resonant LLC power converter shown in FIG. 1B, are limited to a relatively small range of input voltages that can achieve and maintain the desired design output voltage of the operating range of the power converter. Conventional power converters operate in the range of 350 VDC-400Vdc. Applying the new principles described herein, power converters can operate in a range of 120 VDC to 400 VDC of input voltage.

FIG. 1C shows another block diagram of an example LLC resonant DC-DC power converter that includes an inverter 114, a scaled LLC resonant tank circuit 116, and a rectifier 118. The values of the elements of the LLC resonant tank circuit are scaled using both frequency scaling and power scaling factors so the LLC resonant tank circuit 116 is universally designed for a wide range of power converter operating regions.

The power converter shown in block diagram of FIG. 1C and its associated design methodologies provide a way to generate LLC converters through identifying a kernel or exemplary set of values for the LLC tank circuit from which other LLC tank circuits, with different operating parameters, (and thus other LLC power converters) can be designed. The values of the elements of the LLC tank circuit are scaled based on frequency and power scaling techniques described herein.

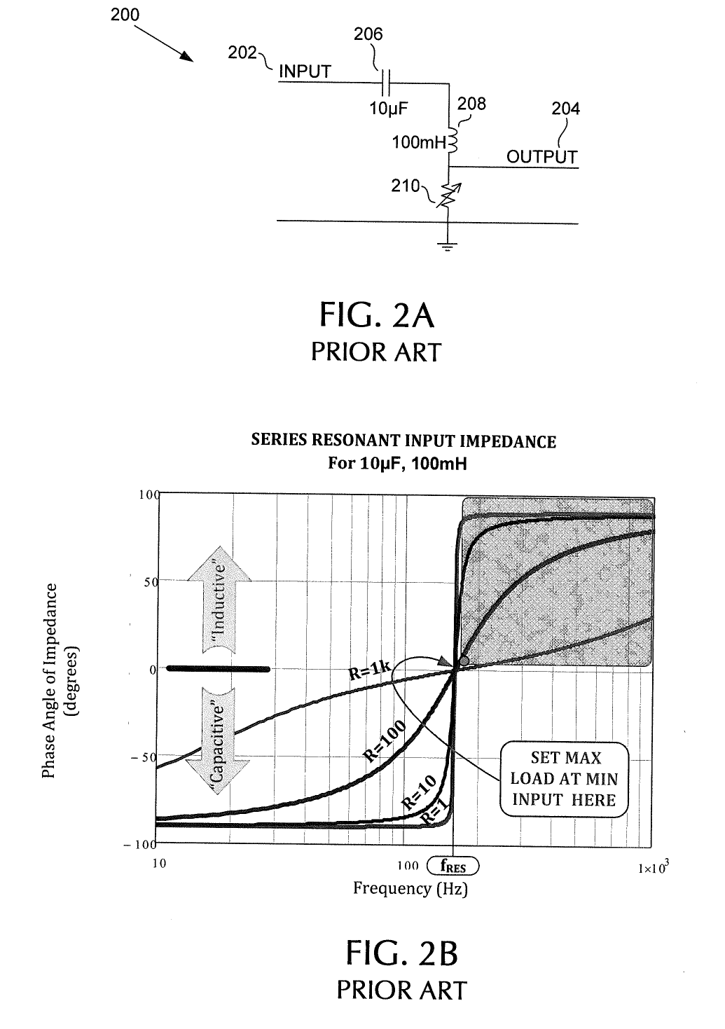

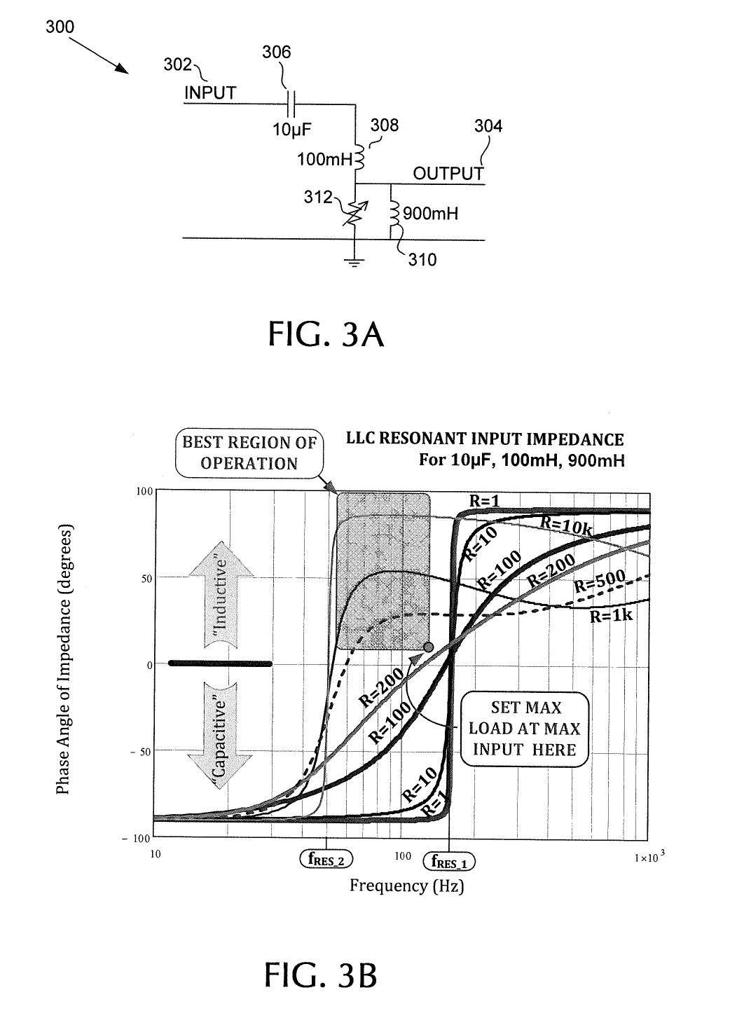

FIGS. 2A and 3A show circuit schematics 200, 300 and FIGS. 2B and 3B, respectively, show associated plots of the phase angle v. frequency for various loads of an LC series resonant power converter and an LLC series resonant power converter, respectively. The LC series resonant tank circuit schematic 200 shown in FIG. 2A has an input 202 (from any suitable input conversion block, such as the inverter shown in FIG. 1C) and an output 204 (resulting in any suitable output block, such as the rectifier shown in FIG. 1C). The LC series resonant tank circuit 200 also has a capacitor 206 value of 10 μF, an inductor 208 value of 100 mH, and a variable resistor 210 that can vary the applied load.

The LC series resonant power converter shown in FIG. 2 is limited by its topology to a single resonant frequency above which (to the right of the resonant frequency shown on the plot of FIG. 2B) is the best operating region for the power converter. The best operating region of the power converter is defined by the region in which the LC tank circuit 200 is inductive (has a positive phase angle) and is at or above the resonant frequency. In the LC series tank circuit shown in FIG. 2A, the resonant frequency is 159 Hz and the best operating region is defined above the resonant frequency value. The plot in FIG. 2 shows the phase angle as frequency increases when various loads are applied at 1Ω, 10Ω, 100Ω, and 1000Ω to the LC power converter. In order to remain within the best operating region, the LC power converter requires that the operating point at maximum load (resistance) that can be applied and the minimum voltage input of the converter is to the right of resonance frequency of the LC tank circuit 200.

The LLC series resonant tank circuit schematic 300 shown in FIG. 3A has an input 302 (from any suitable input conversion block, such as the inverter shown in FIG. 1C) and an output 304 (resulting in any suitable output block, such as the rectifier shown in FIG. 1C). The LLC series resonant tank circuit 300 also has a capacitor 306 value of 10 μF and an inductor 308 value of 100 mH, similar to the LC series resonant tank circuit schematic shown in FIG. 2A. The LLC series resonant tank circuit 300 also includes a second inductor 310 value of 900 μF. The variable resistor 312 varies the load in the same manner as in the LC series resonant tank circuit schematic shown in FIG. 2A. Because of the two inductors 306 and 308, the LLC tank circuit 300 produces two resonant frequencies, as shown in the plot of FIG. 3B.

The inductors of the LLC tank circuit 300 can be any suitable inductance source, including discrete inductors and parasitic inductance. The selected values of the first inductor and the second inductor can be in any desirable ratio. In some examples, the second inductor has a value that is 3-10 times greater than the value of the first inductance.

The best operating region for the LLC power converter is within the range of frequencies between the first and the second resonant frequencies, which is the region in which an inductive phase angle is also produced. For the LLC tank circuit shown in FIG. 3A, the resonant frequencies are 50 Hz and 159 Hz. The range of frequencies for best operation of the LLC converter is lower than the frequency at which the best operation can be reached for the LC converter of FIG. 2A since the best operation is now to the left of the resonant frequency of the LLC converter of FIG. 2A. The LLC power converter can operate down to lower frequencies for a range of applied loads.

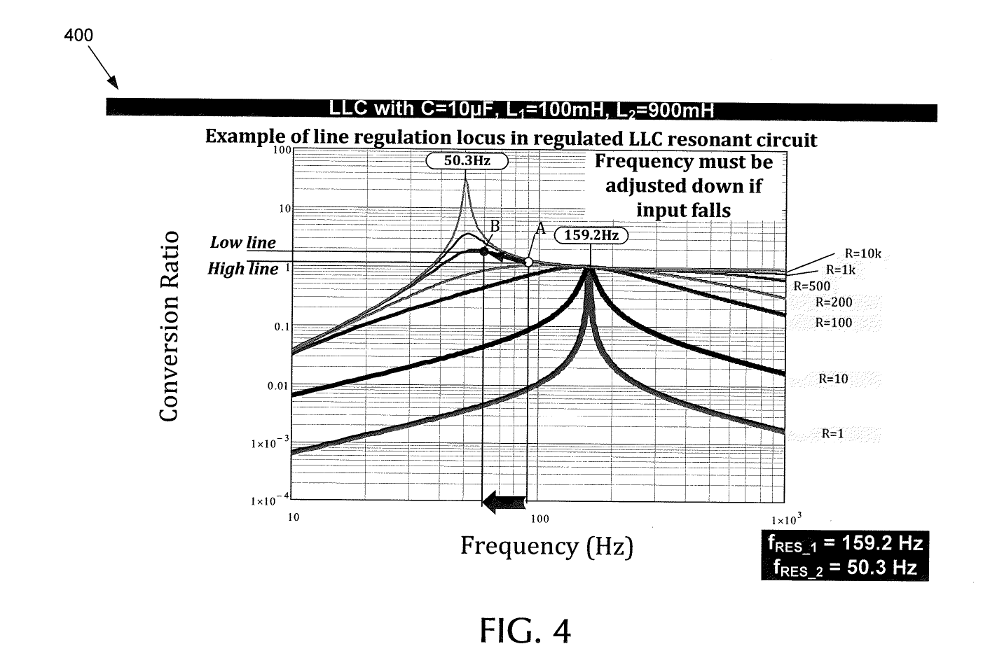

FIG. 4 shows a plot 400 of the gain or conversion ratio of the LLC power converter (i.e., the LLC tank circuit shown in FIG. 3A) for a range of applied loads and the associated input (line) regulation. The conversion ratio is the output voltage of the LLC tank circuit divided by the input voltage of the LLC tank circuit in which the output voltage is the voltage across the second inductor (the 900 mH inductor shown in example schematic of an LLC tank circuit in FIG. 3A). The second inductor may be magnetically coupled with a third inductor (not shown) to develop a different output voltage based on turns ratio, and for clarity, the LLC converter stage is defined without reference to any such turns ratio conversion.

At low voltage input, the operating frequency of the LLC converter must be decreased for loads equal to or in excess of a predetermined minimum since the conversion ratio increases when the voltage input decreases and thus the frequency is adjusted down to remain within the desired frequency range between the two defined resonant frequencies.

Also shown in FIG. 4, is the conversion ratio values for the low end 402 of the range of voltage input that the LLC power converter can effectively regulate and the high end 404 of the voltage input that the LLC power converter can effectively regulate. By operating within the frequency range defined by the two resonant frequencies of the LLC tank circuit, the LLC power converter can maintain its intended step-up or step-down power conversion over a wide range of applied loads. More specifically, at applied loads near the lower end of the allowed range, the operating frequency will shift close to the high end of the resonant frequency range and at very heavy loads of the allowed range, the operating frequency shifts closer to the low end of the resonant range. Loads lighter than the allowed range do not exhibit the second resonance peak and are considered to be outside of the allowed range.

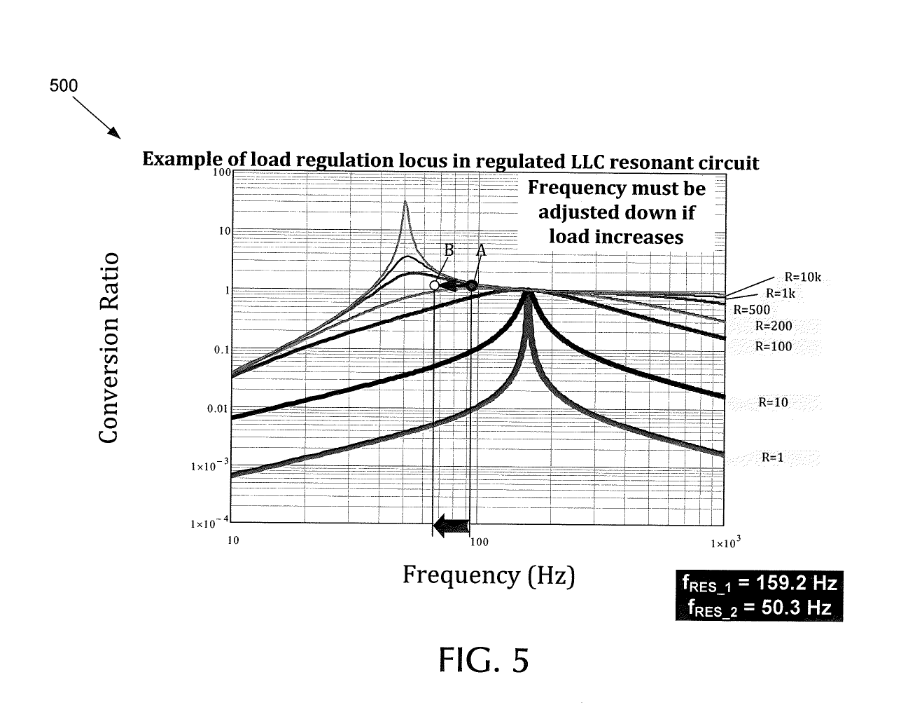

FIG. 5 shows a plot of the conversion ratio of the LLC power converter 500 (the LLC tank circuit shown in FIG. 3A) for a range of applied loads, shown as load level A and load level B and the associated load regulation. As shown in the plot, the switching frequency of the LLC power converter must be adjusted down as the applied load increases from load level A to load level B. In the example plot shown in FIG. 5, load regulation is achieved with only a small change in switching frequency.

Changing the frequency at which the LLC power converter operates can be done by an output voltage to switching frequency controller, as compared to conventional converters that have controllers that change the signal's duty cycle. The output voltage to switching frequency controller increases the switching frequency in response to a decreasing input voltage and when the applied load is increased. The output voltage to switching frequency controller of the LLC power converter also automatically corrects for any lowering of the line or input voltage. The design entry point for designing the LLC tank circuit may be advantageously set at maximum load and maximum line to account for the range of input voltage and range of applied loads.

The relationship between the conversion ratio and the input voltage and applied load is shown in FIGS. 4 and 5 above. The output voltage to switching frequency controller can be any suitable controller designed to vary the switching frequency of the LLC power converter's tank circuit.

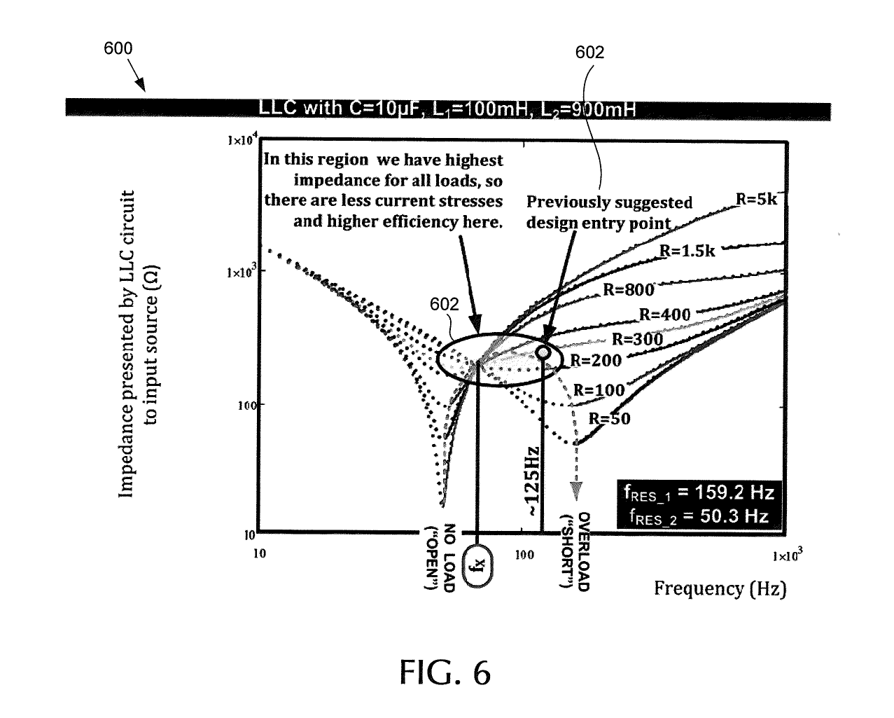

FIG. 6 shows a plot of the input impedance over a range of frequencies for the LLC tank circuit. The region of operation for the LLC converter is shown to be between no load and overload (defined by the parameters of the LLC converter). Within the identified operating region, the LLC converter produces the highest input impedance of the LLC tank circuit for all applied loads (the desired range of applied loads), which results in less current stresses and higher overall switching efficiency. The frequency locus at which all of the applied loads produce the highest input impedance of the LLC tank circuit is circled 602 in FIG. 6.

The previously suggested design entry point 602 is also shown on the plot of the input impedance over a range of frequencies for the LLC tank circuit. The previously suggested design entry point 602 is about 125 Hz and does not accommodate for the lower range of operating frequencies within which the impedance is highest for all applied loads.

All of the plots shown in FIGS. 3A-6 help to identify the appropriate design entry point for determining the values of the elements in the LLC tank circuit. At maximum load and maximum line (voltage input), the two resonant frequencies defined by the values of the LLC tank circuit control the operating parameters of the LLC power converter. For example, the start of the EMI test region occurs when the LLC power converters operates at over about 150 kHz. The values of the LLC tank circuit can be selected so the high resonant frequency is defined at being no greater than 150 kHz, which reduces EMI and increases the overall converter efficiency.

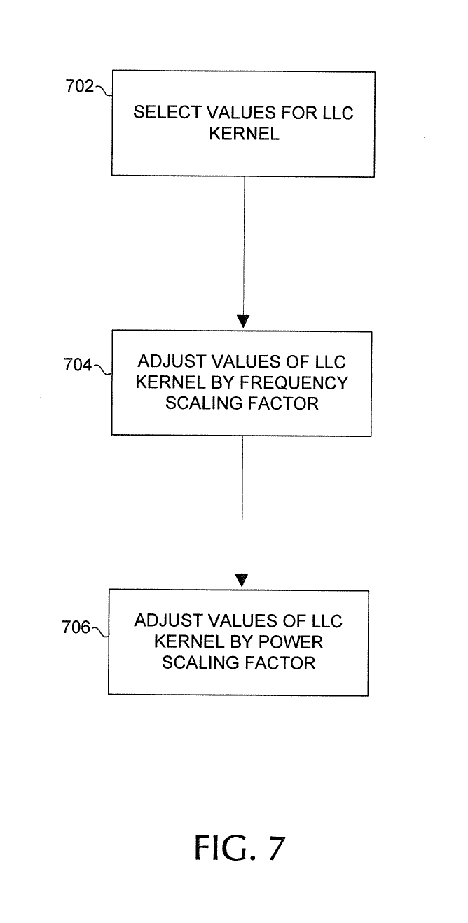

Turning now to FIG. 7, an example design methodology for determining values of the components for an LLC tank circuit is shown. First, an LLC “kernel” is selected and the values of each of the two inductors and the capacitor are chosen 702. In some examples, the LLC kernel is an LLC kernel that operates as desired at a low-frequency. The values of the low-frequency LLC kernel are then scaled to the desired frequency operating range for the LLC power converter, which may be higher than the frequency at which the low-frequency LLC kernel would optimally operate.

The LLC kernel component values can be arbitrarily chosen or can be chosen such that a particular ratio is selected between the two inductors (or inductances). In some examples, the values of the first inductor, the second inductor, and the capacitor are selected such that the design output voltage is maintained over a range of input voltages that range from 65% to 100% of the design maximum input voltage with an efficiency of at least 90% over that range defined at the maximum design load.

In another example, the LLC tank circuit values are selected such that the design output voltage is maintained over a range of input values, from 50% to 100% of the design maximum input voltage. In still other examples, the range of input values is 25% to 100%.

The disclosed design methodology for selecting values of the components of the LLC tank circuit enables an efficiency of at least 90% of the maximum design load over the input voltage range of 65% to 100% by selecting values that result in soft-switching over the voltage input range.

Values of the first inductor, the second inductor, and the capacitor are adjusted by a frequency scaling factor that includes a ratio of the maximum resonant frequency and minimum resonant frequency of the LLC kernel 704. The values of the first inductor, the second inductor, and the capacitor are “scaled” (or divided) by a ratio by which the frequency needs to be increased for the LLC power converter to operate as desired in the soft switching region. Because frequency depends on the product of the value of the first inductor and the capacitor, but the load depends on the value of the first inductor divided by the value of the capacitor, the load does not change, but the frequency increases for the LLC power converter. After frequency scaling is performed on the LLC kernel values, the result is a high-frequency LLC kernel in which the optimum maximum load remains the same, irrespective of input voltage.

The values of the first inductor, the second inductor, and the capacitor are further adjusted by a power scaling factor that includes a ratio of the peak power output of the LLC kernel when the maximum line (input voltage) is applied and a peak power output of the LLC kernel when the maximum design load is applied to the LLC kernel 706. Because the optimum load for the high-frequency LLC kernel was identified during frequency scaling, the output power of the LLC tank circuit is also known based on the selected load.

Different applications for the LLC power converter have different power requirements. The LLC kernel values can further be power scaled by altering the value of the inductors and the capacitor so the frequency does not change, but rather the applied load changes. With the new, different applied load, the frequency and power scaled LLC tank circuit produces the same load that was produced prior to scaling the LLC tank circuit values.

The power scaling factor is the ratio between the maximum power output of the originally selected LLC kernel values and the desired power output for the LLC power converter. The values of both of the inductors are divided by the power scaling factor and the value of the capacitor is multiplied by the power scaling factor. The same switching frequency of operation for the LLC power converter is maintained, but the power is increased. To reach a greater range of input voltages, the LLC tank circuit is designed for a high power capability at the maximum line, which becomes the design entry point for the LLC power converter.

For example, a universal input AC-DC LLC converter is needed that can output 12V and 20 W. The example AC-DC converter has an LLC kernel with component values of 100 mH, 900 mH, 10 μF, and 300Ω, such as the LLC tank circuit values that are shown in FIG. 3A. A 400VDC input, when switched produces a square wave excitation on the LLC tank circuit of the converter, of an amplitude of 200 VDC (half peak-to-peak value). The corresponding AC amplitude is more: 4/π*200V=254.6 VAC (amplitude). By selecting the right load, the gain (or conversion ratio) is 1.05 times. The output voltage of the LLC tank circuit is 254.6V*1.05 (gain)=267.33V. The LLC tank circuit has an optimum resistance of 300Ω, thus the power output of the LLC tank circuit is (267.33V)²/300 Ω=238.22 W.

The design parameters require 20 W average DC output power over the entire input voltage range. Applying an efficiency rate of 85%, the design parameters need to aim to output 20 W/0.85=23.53 W. In other examples, the efficiency rate is 90% or more. However, at the low voltage (line) input, the LLC tank circuit needs to output at least five times more power, which is approximate 235 W of peak power at the maximum voltage input. Therefore, the power scaling factor for the LLC tank circuit values is 235 W (peak power capability needed from the LLC tank circuit)/238.22 W (calculated peak power of the LLC tank circuit at maximum load)=0.99.

Additionally, the design parameters require the maximum operating frequency to be 140 kHz to reduce or avoid EMI issues. Using inductor values for the two inductors of the LLC tank circuit with a ratio of 1:9 (or any other suitable ratio, such as a 1:3 ratio) creates a frequency spread between the two resonant frequency peaks of the LLC tank circuit separated as per 1:110, which is 1:3.16. The ratio defines the high-frequency resonant peak to always be 3.16 times greater than the frequency of the lower-frequency resonant peak. For the example in which the design parameter requires that the LLC converter operate below 140 kHz, the lowest frequency is set to 140 kHz/3.16=44 kHz and the highest frequency does not exceed 140 kHz.

The frequency scaling factor is 44 kHz (lowest operating frequency for the LLC power converter)/50 Hz (low frequency resonant peak for the LLC tank circuit)=880. The values of the inductors and capacitors are scaled by dividing their respective values by the frequency scaling factor. In the example in which the LLC tank circuit has values of 100 mH, 900 mH, and 10 μF, the frequency scaled values of the LLC tank circuit elements are as follows:

L₁: 100 mH→L₁/frequency scaling factor=100 mH/880=113.6 μH

L₂: 900 mH→L₂/frequency scaling factor=900 mH/880=1022.7 μH

C: 10 μF→C/scaling factor=10 μF/880=11.36 nF

The values of the LLC tank circuit elements are further adjusted by applying the power scaling factors to the frequency scaled values, as follows:

L₁: 113.6 H→L₁/power scaling factor=113.6 μH/0.99=115 μH

L₂: 1022.7 μH→L₁*9=115 μH*9=1.035 mH

C: 11.36 nF→C*power scaling factor=11.36 nF*0.99=11.5 nF

The frequency-scaled and power-scaled values of the LLC tank circuit in this example are good for 235 W of peak power at high line (input voltage). The value of the loading resistor to output the peak power from the LLC tank circuit is (267.33V)²/235 W=304.1Ω (maximum voltage output of the LLC tank circuit²/peak power output of the LLC tank circuit).

In the case in which a 1:1 transformer is used with a rectified DC output, the load resistor across the output will produce 304.1Ω applied load across the LLC tank circuit, which needs to be larger by the amount π²/8=375.2Ω. The peak power is calculated at the top of a sine-squared waveform so the average DC power output is 235 W/2=117.5 W. For a rectified DC output with a 1:1 transformer, the intermediate rectified DC rail (voltage) is =√(Pₒᵤₜ*Rₒᵤₜ)=√(117.5 W*375.2Ω)=210V. The intermediate rectified DC voltage also can be calculated by: (V_{INMAX}/2)*gain=(400V/2)*1.05=210V.

The turns ratio of the transformer steps-down the intermediate rail (voltage) to the actual output rail (voltage)=1/n=(output voltage of the LLC power converter+output voltage of the output diode)/intermediate rectified DC voltage=(12V+0.7V)/210V=0.06=16.535. The first inductor in this example can be a leakage inductance of 115 μH and the second inductor is 1.035 mH (1:9 ratio) and the capacitor is 11.5 nF. The turns ratio of the transformer is 16.54 (or the inverse 0.06, depending on the type of simulator being used).

Sometimes a gain correction needs to be applied to the frequency and power scaling techniques described above. The resonant frequencies are calculated based on an ideal LLC tank circuit without a load. When the LLC tank circuit is loaded in practice, the resonant frequency may shift slight lower and thus a gain correction may need to be applied.

Having described and illustrated the principles of the invention in a preferred embodiment thereof, it should be apparent that the invention can be modified in arrangement and detail without departing from such principles. I claim all modifications and variations coming within the spirit and scope of the following claims.

1. An LLC tank circuit with a design maximum input voltage and design output voltage, the LLC tank circuit, comprising:
a first inductor;
a second inductor electrically coupled in series with the first inductor; and
a capacitor electrically coupled in series with the first inductor and the second inductor,
wherein values of the first inductor, the second inductor, and the capacitor are selected such that the design output voltage is maintained over a range of input voltages from at least 65% to 100% of the design maximum input voltage with an efficiency of at least 90% at maximum design load over the input voltage range 65%-100%.

2. The LLC tank circuit of claim 1, wherein the first inductor includes a parasitic inductance.

3. The LLC tank circuit of claim 1, wherein the first inductor is a discrete inductor.

4. The LLC tank circuit of claim 1, wherein the first inductor has a first inductance and the second inductor has a second inductance that is 9 times greater than the first inductance.

5. The LLC tank circuit of claim 4, wherein the applied load is applied across the second inductor.

6. The LLC tank circuit of claim 5, wherein the applied load is applied directly across the second inductor.

7. The LLC tank circuit of claim 5, wherein the applied load is applied by turn-ratio winding that is coupled to the second inductor.

8. The LLC tank circuit of claim 1, wherein the design output voltage is maintained over the range of input voltages from 20% to 100% of the design maximum input voltage when the applied load varies between the maximum design load and no load.

9. The LLC tank circuit of claim 1, wherein a frequency of the LLC converter stage is fixed between a first limit and a second limit, the first limit defined by resonant frequency peaks formed by a frequency of the first inductor, the second inductor, and the capacitor and the second limit defined by resonant frequency peaks formed by a frequency of the first inductor and the capacitor.

10. The LLC tank circuit of claim 1, wherein an inductive phase angle is maintained through the range of input voltages.

11. The LLC tank circuit of claim 1, wherein the values of the first inductor, the second inductor, and the capacitor are selected such that the design output voltage is maintained over a range of input voltages from 50% to 100% of the design maximum input voltage.

12. The LLC tank circuit of claim 1, wherein the values of the first inductor, the second inductor, and the capacitor are selected such that the design output voltage is maintained over a range of input voltages from 25% to 100% of the design maximum input voltage.

13. The LLC tank circuit of claim 1, wherein an applied load varies between the maximum design load and 50% of the maximum design load.

14. An LLC converter stage with a design maximum input voltage and design output voltage, the LLC converter stage comprising:
an output voltage to switching frequency controller;
a first inductor;
a second inductor electrically coupled in series to the first inductor; and
a capacitor electrically coupled in series with the first inductor and the second inductor,
wherein values of the first inductor, the second inductor, and the capacitor are selected such that the design output voltage is maintained over a range of input voltages from at least 65% to 100% of the design maximum input voltage, with an efficiency of at least 90% at maximum design load over the input voltage 65%-100%.

15. A method of operating an LLC tank circuit, comprising:
selecting values for an LLC kernel that includes:
a first inductor;
a second inductor electrically coupled in series with the first inductor; and
capacitor electrically coupled in series with the first inductor and the second inductor,
wherein values of the first inductor, the second inductor, and the capacitor are selected such that the design output voltage is maintained over a range of input voltages from at least 65% to 100% of the design maximum input voltage with an efficiency of at least 90% at maximum design load over the input voltage range 65%-100%;
adjusting values of the first inductor, the second inductor, and the capacitor by a frequency scaling factor that is a ratio of a maximum frequency of the kernel and a minimum frequency of the kernel; and
further adjusting the frequency adjusted values of the first inductor, the second inductor, and the capacitor by a power scaling factor that is a ratio of a peak power output of the kernel at maximum line and a peak power output when the maximum design load is applied to the kernel.

16. The method of claim 14, further comprising:
providing an output voltage to switching frequency controller; and
operating the output voltage to switching frequency controller based on the output voltage measured from the LLC tank circuit.
